(19) United States
(12) Patent Application Publication
(10) Pub. No.: US 2014/0335250 A1
(43) Pub. Date: Nov. 13, 2014

(54) METHOD AND SYSTEM FOR MAKING ICE CREAM ON A STICK AND MACHINE FOR MAKING AND DISPENSING A LIQUID OR SEMILIQUID PRODUCT FOR MAKING ICE CREAM ON A STICK

(71) Applicant: ALI S.p.a. - CARPIGIANI GROUP, Milano (IT)

(72) Inventors: Andrea COCCHI, Calderara di Reno (Bologna) (IT); Roberto LAZZARINI, Reggio Emilia (IT)

(73) Assignee: ALI S.p.a. - CARPIGIANI GROUP, Milano (IT)

(21) Appl. No.: 14/273,070

(22) Filed: May 8, 2014

(30) Foreign Application Priority Data
May 10, 2013 (IT) BO2013A000213

(51) Int. Cl. A23G 9/26

(52) U.S. Cl. CPC A23G 9/26
USPC 426/512; 99/455

(57) ABSTRACT

A method for making of ice cream on a stick, includes the following steps: subjecting a liquid or semiliquid base product to cooling and stirring inside a container to obtain a processed liquid or semiliquid product; drawing the processed product from the container to fill cavities of a mould; inserting sticks in the mould; cooling the mould, filled with the processed product and containing the sticks, so as to obtain ice creams on a stick.

This application claims priority to Italian Patent Application B020 A000213 filed May 10, 2013, the entirety of which is incorporated by reference herein.

### BACKGROUND OF THE INVENTION

The present invention relates to a method and a system for making ice cream on a stick and a machine for making and dispensing a processed liquid or semiliquid product suitable for forming ice cream on a stick.

Ice creams on a stick are ice creams consisting of a bar of ice cream, embedded in which there is a portion of a stick, usually made of wood or plastic, which serves as a hand grip.

In the technical field in question, the ice cream is produced by directly inserting a base liquid or semiliquid mixture into a mould which defines cavities for containing a liquid or partially liquid product.

The mould is subjected to abrupt cooling, at relatively low temperatures in order to cause the base mixture to freeze and thus obtain the finished product.

The base liquid or semiliquid mixture is usually subjected to a pasteurisation treatment before being introduced into the mould.

An operator introduces the base liquid or semiliquid mixture into the mould by means of a pitcher, for example he/she introduces a sweetened milk-based mixture.

A particularly felt need in the sector in question is that of obtaining an ice cream type product on a stick endowed with a high overrun, i.e. which incorporates a particularly high percentage of air.

In fact, the method used up to now does not enable one to obtain an ice cream on a stick type product endowed with a high overrun.

### SUMMARY OF THE INVENTION

The object of the present invention is to satisfy the need expressed above by providing a machine, a system and a method enabling the production of ice cream on a stick.

In accordance with the invention, this object is achieved by a method and a system for making ice cream on a stick and a machine for making and dispensing a liquid or semiliquid product for making ice cream on a stick.

### BRIEF DESCRIPTION OF THE DRAWINGS

The technical features of the invention, according to the aforesaid objects, are clearly inferable from the contents of the claims set forth below, and the advantages of the same will be more apparent from the detailed description that follows, made with reference to the appended drawings, which represent a purely illustrative, nonlimiting embodiment, in which:

FIG. 1 illustrates a perspective view of the machine and system of the present invention according to a first embodiment;

FIG. 2 illustrates a perspective view of the machine and system of he present invention in accordance with a second embodiment;

FIG. 3 illustrates a perspective view of the machine and system of the present invention in accordance with a third embodiment.

### DESCRIPTION OF THE PREFERRED EMBODIMENTS

It should be observed that in the appended figures, the proportions of the graphic elements are not representative of those of the real elements: in particular, the machine 1 has been deliberately drawn on an enlarged scale.

According to the invention, a method for making ice cream on a stick is defined.

The method of the invention comprises the following steps:
subjecting a liquid or semiliquid base product to cooling and stirring inside a container 2 to obtain a processed liquid or semiliquid product;
drawing the processed product from the container 2 to fill cavities 4 of a mould
inserting sticks (preferably made of plastic material or wood) into the mould 3;
cooling the mould 3, filled with the processed product and containing the sticks, to obtain ice creams on a stick.

This method can be implemented by a machine 1 for making and dispensing a processed liquid or semiliquid product for ice cream on a stick and by a system 20 for making ice cream on a stick.

A machine 1 for making and dispensing a processed liquid or semiliquid product for ice cream on a stick (also part of the subject matter of the invention) and a system 20 (also part of the subject matter of the invention) for making ice cream on a stick are described below.

The machine 1 for making and dispensing a processed liquid or semiliquid product for ice cream on a stick comprises a container 2 for containing a liquid or semiliquid base product.

It should be observed that the liquid or semiliquid base product preferably comprises a milk-based mixture.

The machine 1 according to the invention comprises a unit 10 for mixing and cooling the liquid or semiliquid base product; it is associated with the container 2 to allow the base product to be mixed and cooled in the container 2 in such a way as to obtain a liquid or semiliquid processed product.

It should be observed that the mixing and cooling unit 10 comprises a thermal treatment system and a stirrer 6.

The stirrer 6 is operatively active on the base product so as to achieve a mixing of the same.

The thermal treatment system comprises a circuit in which an operative (refrigerant) fluid is active.

It should be observed that the thermal treatment system is preferably configured to carry out a thermal cycle via the refrigerant fluid.

In particular, the thermal treatment system is preferably configured so as to define a cooling cycle.

The thermal treatment system preferably comprises the following components associated with the circuit:
first heat exchange means (an evaporator) operatively active on the container 2 in order to achieve a heat exchange between the operating fluid and base product inside the container 2 so as to cool the base product inside the container 2;
second heat exchange means (a condenser) for cooling the operating fluid;
a compressor, operatively active on the refrigerant fluid in order to increase the pressure thereof and disposed in the circuit between the first and the second heat exchange means;
means for reducing the pressure of the fluid (a thermal expansion valve), operatively active on the refrigerant fluid in order to decrease the pressure thereof and disposed in the circuit between the second and the first heat exchange means.

The machine 1 further comprises, according to the invention, extraction means 11 for extracting the processed liquid or semiliquid product, able to be coupled to, and uncoupled from, the container 2 so as to allow the processed product to be drawn from the container 2 and configured to allow an operator to release the processed product into cavities 4 of a mould 3 for making ice cream on a stick.

Preferably, the extraction means 11 for extracting the processed liquid or semiliquid product comprise a hose 9, connectable to the container 2 to allow the processed liquid or semiliquid base product to be extracted from the container 2 itself.

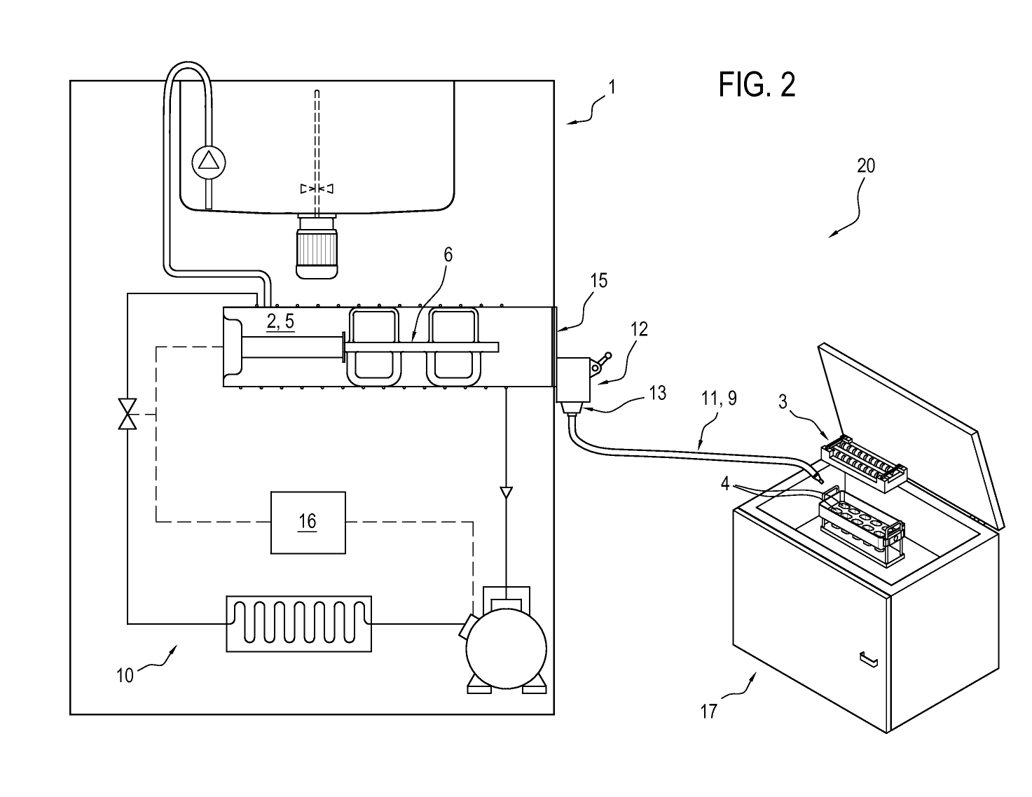

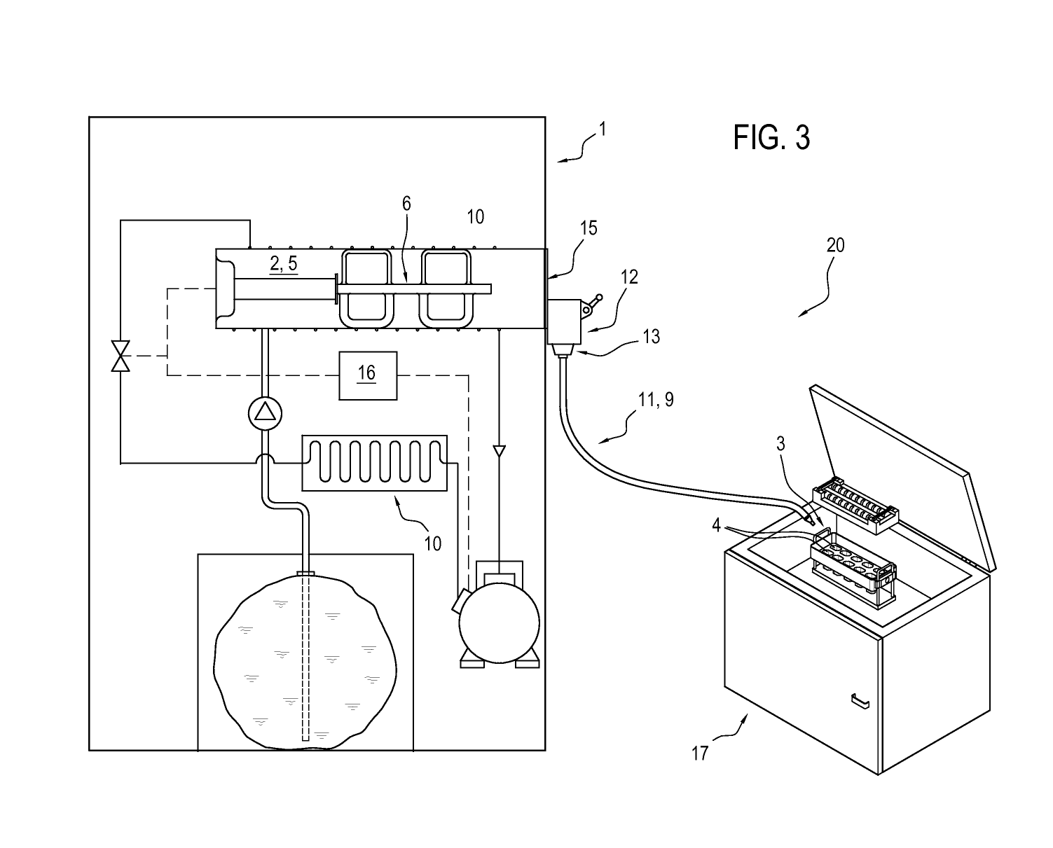

The embodiment of the machine 1 illustrated in FIGS. 2 and 3 will now be described.

According to this embodiment, the machine 1 preferably comprises a dispenser 12 coupled to the container 2 to allow a user to draw the processed product from the container 2 and to dispense the selfsame processed product.

In accordance with this embodiment, the machine 1 comprises means 13 for coupling the hose 9 to the dispenser 12.

Preferably, the hose 9 is a rubber hose.

It should be observed that, according to this aspect, the hose 9 is coupled to the container 2 via the dispenser 12.

According to the example illustrated in FIGS. 2 and 3, the container 2 is defined by a batch freezing cylinder 5, comprising a door 15 for closing and isolating the container 2 from the outside atmosphere.

It should be observed that the batch freezing cylinder 5 is provided with an internal chamber for processing and mixing the base material.

The batch freezing cylinder 5 is directly cooled by the thermal treatment system.

In particular, one of the exchangers (evaporator) of the thermal treatment system is coupled to the batch freezing cylinder 5.

It should be observed that, preferably, the exchanger (evaporator) is disposed in such a way as to cool the lateral wall of the batch freezing cylinder 5.

In particular, according to this embodiment, the stirrer 6 is configured to scrape at least part of the lateral walls of the batch freezing cylinder 5.

Preferably, in accordance with this embodiment implementing the method, the step of subjecting a liquid or semiliquid base mixture to cooling and stirring inside a container 2 envisages a step of cooling the base product to a temperature comprised between −3° C. and −15° C.

It should be observed, then, that the machine 1 comprises an electronic unit 16, configured to control one or more components of the thermal treatment system so as to cool the base product to a temperature comprised between −3° C. and −15° C.

Therefore, according to this embodiment of the method, the step of subjecting the liquid or semiliquid base product to cooling and stirring inside a container is carried out inside a batch freezing cylinder 5, which can be sealedly isolated from the outside atmosphere.

Moreover, according to this embodiment, the step of drawing the processed product from the container 2 to fill the mould 3 preferably comprises the step of switching on the stirrer 6 to facilitate outflow of the product from the container 2.

It should likewise be observed that during the step of subjecting the liquid or semiliquid base product to cooling and stirring, the pressure inside the batch freezing cylinder 5 is greater than the atmospheric pressure.

In particular, the pressure inside the batch freezing cylinder 5 is preferably comprised between 1.5 bar and 2.5 bar.

According to this embodiment, there is preferably envisaged a cooling combined with mixing of the base product inside the batch freezing cylinder 5.

More in general, according to the method, the step of subjecting the liquid or semiliquid base product to cooling and stirring preferably comprises a step of simultaneous cooling and mixing.

It should be observed that the batch freezing cylinder 5, according to the embodiment illustrated in FIG. 2, is fed (i.e. receives the base product) by means of an upper tank.

In contrast, the batch freezing cylinder 5, according to the embodiment illustrated in FIG. 3, is fed (i.e. receives the base product) by means of a bag-in-box type of container.

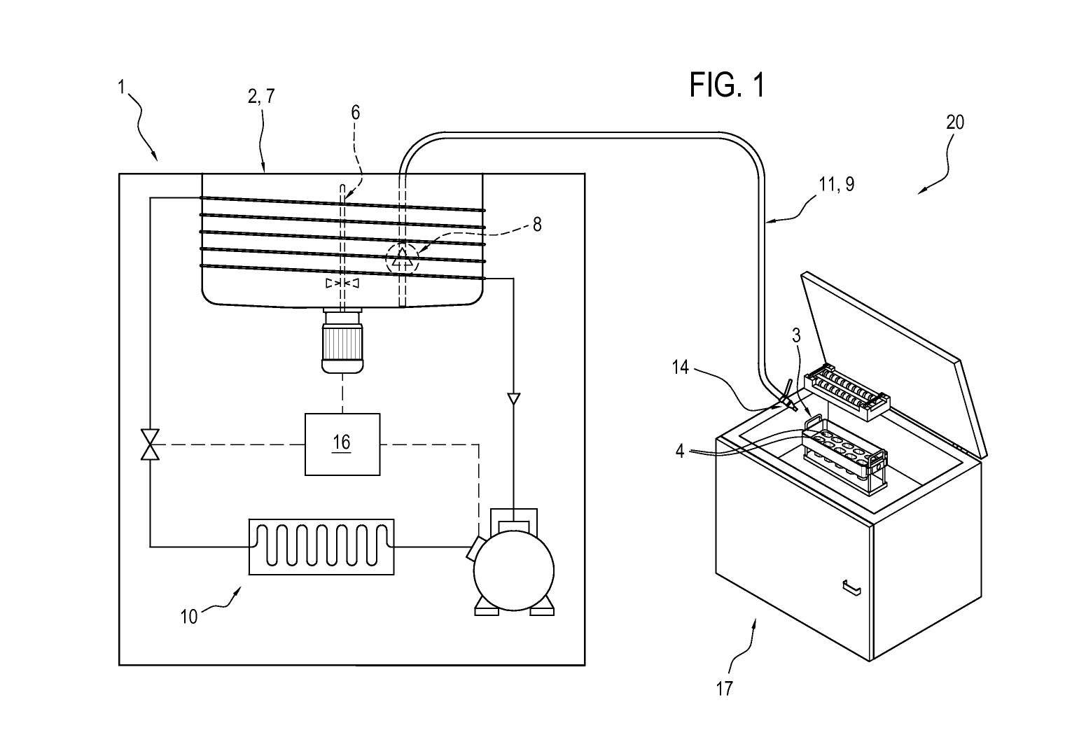

The embodiment illustrated in FIG. 1 will now be described.

In accordance with this embodiment, the container 2 is defined by a tank 7.

It should be observed that the tank 7 comprises a stirrer 6.

According to another aspect, the hose 9 is equipped with closing means 14, which can be operated by the user to prevent the processed product from flowing in the hose 9.

It should be observed that, according to this aspect, the hose 9 comprises a mechanical device 14 for closing off the hose 9 itself, which allows the user to open and close the hose for dispensing the product.

Preferably, according to this embodiment, the machine 1 comprises a pump 8.

The pump 8 is configured to draw the processed product from the tank 7.

In particular, it may be observed, therefore, that the intake side of the pump 8 is connected to the tank 7, in particular to the bottom of the tank 7.

In this embodiment, the hose 9 is connected to the delivery side of the pump 8.

It should be observed, then, that according to this embodiment of the method, the step of drawing the processed product from the container 2 to fill a mould 3 comprises a step of transferring the processed product through the pump 8.

In other words, the pump 8 is switched on to draw the processed product from the container 2 and fill cavities 4 of a mould 3: in fact the pump 8 generates the necessary head for transferring the processed product through the hose 9.

Likewise defined according to the invention is a system 20 for making ice cream on a stick, comprising;
a machine 1 for making and dispensing a processed liquid or semiliquid product so as to obtain ice cream on a stick, already described previously:
a mould 3 provided with a plurality of cavities 4 which can be filled with the processed liquid or semiliquid product;
a cooling unit 17 for the mould 3, configured to allow cooling of the mould 3 (with the cavities 4 filled with the processed product and containing a stick) to a temperature such as to allow the processed product to solidify inside the cavities 4, so as to obtain ice creams on a stick.

It should be observed that the cooling unit 17 for the mould 3 is configured to allow the processed product to be cooled to a temperature below −15° C. (preferably comprised between −15° C. and −35° C.).

It should be observed that, even more preferably, the cooling unit 17 for the mould 3 is configured to allow the processed product to be cooled to a temperature below −20°C. (preferably comprised between −20° C. and −35° C.).

It should be observed that, in the illustrated figures, the mould 3 is filled with a processed liquid or semiliquid product when the mould 3 is placed inside the cooling unit 17.

Alternatively, the mould 3 is filled with a processed liquid or semiliquid product when the mould 3 is placed outside the cooling unit 17 and the mould 3 is placed inside the cooling unit 17 after being filled.

After filling, a stick support element supporting a plurality of sticks is coupled to the mould 3, so that a stick is placed in each cavity 4 filled with product.

Preferably, the cooling unit 17 for the mould 3 is a rapid temperature reducing unit.

The expression “rapid temperature reducing unit” means a unit equipped with a cooling system configured to enable the product inside it to be cooled in an extremely rapid and fast manner.

Preferably, the rapid temperature reducing unit is provided with a compartment for accommodating the mould and a door which can be opened and closed to allow access to the compartment.

Preferably, the evaporator of the cooling system is configured to cool the compartment.

According to the invention, the machine 1 enables a mixture to be obtained which is particularly suitable for making ice creams on a stick.

In particular, experimental tests have enabled technical personnel to observe that the ice cream on a stick obtained by means of the method of the invention, or by means of the system 20, is endowed with a high overrun, i.e. incorporates a large amount of air, which improves its sensory qualities.

It should be observed that overrun means:

$$\frac{WEIGHT OF MIXTURE - WEIGHT OF ICE CREAM}{WEIGHT OF ICE CREAM} \times 100$$

Therefore, the processed product obtained by means of the machine 1 makes it possible, compared to traditional methods of making ice cream on a stick, to obtain ice cream on a stick endowed with a high overrun, i.e. which incorporates a large amount of air.

In particular, it should be observed that the method implemented according to the embodiment in FIG. 1 allows a large amount of air to be incorporated: in fact the action of the pump 8 causes a sort of emulsion of air in the processed liquid to be created, or, in other words, it favours the incorporation of air.

Therefore, advantageously, the machine 1, the system 20 and the method according to the invention makes it possible to obtain an ice cream on a stick endowed with high quality characteristics.

What is claimed is:

1. A method for making ice cream on a stick, comprising the following steps:
subjecting a liquid or semiliquid base product to cooling and stirring inside a container to obtain a processed liquid or semiliquid product;
drawing the processed product from the container to fill cavities of a mould;
inserting sticks in the mould;
cooling the mould, filled with the processed product and containing the sticks, to obtain ice creams on a stick.

2. The method according to claim 1, wherein the step of subjecting a liquid or semiliquid base product to cooling and stirring inside a container is performed in a batch freezing cylinder which can be sealedly isolated from the outside atmosphere.

3. The method according to claim 1, wherein the pressure inside the batch freezing cylinder during the step of subjecting the liquid or semiliquid base product to a cooling and stirring process is greater than the atmospheric pressure outside.

4. The method according to claim 1, wherein the step of drawing the processed product from the container to fill the mould comprises the step of switching on a stirrer to facilitate outflow of the product from the container.

5. The method according to claim 1, wherein the step of subjecting a liquid or semiliquid base product to cooling and stirring inside a container is performed in a tank.

6. The method according to claim 1, wherein the step of drawing the processed product from the container to fill a mould comprises a step of transferring the processed product through a pump.

7. The method according to claim 1, wherein the step of drawing the processed product from the container to fill a mould is performed through a hose connectable to the container.

8. The method according to claim 6, wherein the hose is connected to the delivery side of the pump.

9. The method according to claim 1, wherein the step of subjecting a liquid or semiliquid base mix to cooling and stirring inside a container comprises cooling the base product to a temperature below −3° C.

10. The method according to claim 9, wherein the step of subjecting a liquid or semiliquid base mix to cooling and stirring inside a container comprises cooling the base product to a temperature between −3° C. and −15° C.

11. The method according to claim 10, wherein the step of subjecting a liquid or semiliquid base mix to cooling and stirring inside a container comprises cooling the base product to a temperature between −3° C. and −8° C.

12. The method according to claim 1, wherein the step of cooling the mould filled with the processed product and containing the stick comprises a step of cooling the processed product to a temperature below −20° C.

13. The method according to claim 1, wherein the step of cooling the mould, filled with the processed product and containing the stick, comprises a step of cooling the base product to a temperature of between −35° C. and −20° C.

14. A machine for making and dispensing a liquid or semiliquid product for ice cream on a stick comprising:
a container for containing a liquid or semiliquid base product;
a mixing and cooling unit configured to mix and cool the liquid or semiliquid base product and associated with the container to allow the base product to be mixed and cooled in the container in such a way as to obtain a liquid or semiliquid processed product;
extraction means for extracting the liquid or semiliquid processed product and able to be coupled to, and uncoupled from, the container so as to allow the processed product to be drawn from the container and which are configured to allow an operator to release the processed product into cavities of a mould for making ice cream on a stick.

15. The machine according to claim 14, wherein the extraction means comprise a hose connectable to the container to allow the processed liquid or semiliquid product to be extracted.

16. The machine according to claim 15, comprising a dispenser coupled to the container to allow a user to draw the processed product from the container and to dispense the selfsame processed product, and comprising means for coupling the hose to the dispenser, the hose being coupled to the container through the dispenser.

17. The machine according to claim 15, wherein the hose is equipped with closing means which can be operated by the user to prevent the processed product from flowing in the hose.

18. The machine according to claim 14, wherein the container is defined by a batch freezing cylinder, comprising a door for closing and isolating the container from the outside atmosphere.

19. The machine according to claim 14, wherein the container comprises a stirrer configured to scrape at least a portion of the wails of the container.

20. The machine according to claim 14, comprising an electronic control unit for the mixing and thermal treatment unit, configured to control the mixing and thermal treatment unit in such a way as to allow the base product to be cooled to a temperature below −3° C.

21. A system for making ice cream on a stick, comprising:
a machine for making and dispensing a liquid or semiliquid product for ice cream on a stick;
a mould provided with a plurality of cavities to be filled with the processed liquid or semiliquid product;
a cooling unit for the mould, configured to allow cooling the mould, with the cavities filled with the processed product and each containing a stick, to a temperature such as to allow the processed product to solidify so as to obtain ice creams on a stick.

22. The system according to claim 21, wherein the cooling unit for the mould is configured to allow the processed product to be cooled to a temperature below −20° C.
